(19) United States
(12) Patent Application Publication
(10) Pub. No.: US 2011/0146462 A1
(43) Pub. Date: Jun. 23, 2011

(54) WATTS MAGNETIC WRENCH SYSTEMS

(76) Inventors: Bryan W. Watts, SR., Meridian, MS (US); Bryan Wilson Watts, JR., Meridian, MS (US)

(21) Appl. No.: 12/946,597

(22) Filed: Nov. 15, 2010

Related U.S. Application Data
(60) Provisional application No. 61/289,594, filed on Dec. 23, 2009.

(51) Int. Cl. B25B 23/12; B25B 13/02

(52) U.S. Cl. 81/125; 81/125.1; 173/1

(57) ABSTRACT

Watts Magnetic Wrench provides consumers with a wrench having an embedded magnet that substantially prevents the tool, nuts and bolts from being dropped when being loosened or tightened. This tool may be available in a variety of sizes to accommodate user preferences. The magnet(s) may be heavy duty and strong enough to sufficiently hold the tool to bolts and nuts and vice versa. The magnet is typically flush with the body of the tooling so as to keep the tooling as compact as possible thereby enabling it to function reliably inside confined areas.

### CROSS-REFERENCE TO RELATED APPLICATION

The present application is related to and claims priority from prior provisional application Ser. No. 61/289,594, filed Dec. 23, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of wrenches and more specifically relates to magnetic wrenches.

2. Description of the Related Art

Wrenches are commonly used by mechanics and other individuals performing repairs. Typically, a wrench is a one-piece tool with a U-shaped opening that grips two opposite faces of a bolt or nut. These wrenches may be used in multiple industries and fields that use the circular inclined plane principle of joining or fastening parts or objects together, as well as having significant need for use by home and vehicle owners. Many of the areas in which wrenches must be used for construction or maintenance are in tightly confined areas with little or no space to grasp loosened fasteners or nuts by hand. Fasteners can accidently be dropped into inaccessible areas and lost. Further, wrenches may be lost when dropped which may be expensive and difficult to replace. Dropped wrenches may end up falling into moving parts causing potential damage to persons and equipment. This problem is significant in the automobile and mobile equipment industry.

Magnets are a material or object that produces a magnetic field. This magnetic field is invisible, but is a force that pulls on other ferromagnetic materials like iron and attracts or repels other magnets. Magnets have been used in a variety of applications. A means whereby a magnetic field can be induced is by use of an electromagnet, made from a coil of wire which acts as a magnet when an electric current passes through it, but stops being a magnet when the current stops. These magnets are typically large and require a power source. A need exists for a portable, reliable magnetic means whereby fasteners and tools would be effectively prevented from getting lost.

Various attempts have been made to solve the above-mentioned problems such as those found in U.S. Pat. Nos. 6,955,105; 6,865,971; 3,215,009; 4,738,168; 3,370,490; and 6,295,899. This prior art is representative of wrenches. None of the above inventions and patents, taken either singly or in combination, is seen to describe the invention as claimed.

Ideally, a magnetic wrench should be user-friendly and yet, would operate reliably and be manufactured at a modest expense. Thus, a need exists for a reliable magnetic wrench system to increase efficiency in fastener installation and de-installation processes and to avoid the above-mentioned problems.

### BRIEF SUMMARY OF THE INVENTION

In view of the foregoing disadvantages inherent in the known wrench art, the present invention provides a novel magnetic wrench system. The general purpose of the present invention, which will be described subsequently in greater detail is to provide increased efficiency in fastener installation and de-installation processes.

A wrench is disclosed herein for providing mechanical torquing advantage for use with rotary fasteners comprising: an elongated shank lever member suitable for providing the mechanical torquing advantage; at least one head with a U-shaped opening; (the U-shaped opening having a base and two opposite faces suitable to contact-grip the rotary fastener); at least one imbedded flush-mounted permanent magnet for creating a ferromagnetic force suitable to act on the rotary fastener during at least one engagement, such as tightening or loosening a nut from a bolt or stud.

The elongated shank lever member and head form a continuous rigid manipulator tool. The imbedded flush-mounted permanent magnet is integral-mounted in the U-shaped opening within a particular embodiment of the present invention. The imbedded flush-mounted permanent magnet preferably comprises a horizontally-mounted position within the base to contact-touch at least one surface area on face(s) of rotary fastener(s) as a user torques the rotary fastener. The horizontally-mounted position of the imbedded flush-mounted permanent magnet comprises an orientation such that a north and a south pole are surface-accessible to provide an adjacent magnetic field arcuate between the north and south poles to apply a multi-pull attraction-force on the rotary fastener (from one or more angles as related to an apex face junction, the magnetic attraction force acting substantially on an arcuate horizontal axis). Users are able to manipulate the elongated shank lever member to torque-rotate the rotary fastener that is removably magnetically-secured to the base of the U-shaped opening via the imbedded flush-mounted permanent magnet.

The magnetic wrench in a particular embodiment comprises a combination double-ended version of the continuous rigid manipulator tool having a first end comprising a head with a U-shaped opening and a second end comprising another head having a ring-end. The wrench is hand-grippable and hand-manipulatable, however in alternate embodiments the magnet may be energized by a power source. Further, the present invention may be used in sockets, flare wrenches and other such tools being manually, pneumatically, electrically or otherwise powered. In the double-ended version of the tool both heads may comprise open-ended wrenches, with U-shaped openings. These ends may be oriented at an angle of about fifteen degrees to a longitudinal axis of the elongated shank lever member for ease of use.

The wrench embodiments with one or more ring end may comprises a six-point or twelve-point enclosed opening that grips multiple faces of the rotary fastener. The imbedded flush-mounted permanent magnets may be located in the first ring end and the second ring end in box-end wrench embodiments. The first ring end and the second ring end may be located on offset planes. Other embodiments of the U-shaped opening wrenches may comprise two threadingly connected jaws allowing relationship-adjusting between the jaws to adapt the U-shaped opening to rotary fasteners of different sizes. The jaws may comprise serrated inner faces and operate as a pipe wrench or may have flat surface inner faces and operate in the capacity of a crescent wrench. The base and two opposing faces may each have imbedded flush-mounted permanent magnets installed within them in alternate embodiments. The wrench may further comprise a ratcheting mechanism.

The magnetic wrench system may comprise a kit as disclosed herein offered for sale including a set of sequentially sized magnetic wrenches; a carrying pouch; an adjustable version of the magnetic wrench (pipe and/or crescent); and a user instruction/warranty manual.

Also disclosed herein is a method for using a wrench with imbedded flush-mounted permanent magnet(s) comprising the steps of: inserting a rotatable fastener into a U-shaped opening of the wrench, the U-shaped opening having a horizontally imbedded flush-mounted permanent magnet located in a base such that the rotatable fastener is magnetically secured in the U-shaped opening; rotating the rotatable fastener onto a threaded relationship with a stationary fastener having a helical ridge; and removing the U-shaped opening from touch contact with the rotatable fastener. The method may further comprise the step of rotating the rotatable fastener thereby removing the rotatable fastener from the stationary fastener.

The present invention holds significant improvements and serves as a magnetic wrench system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Watts magnetic wrench, constructed and operative according to the teachings of the present invention.

FIG. 1 shows a perspective view illustrating a magnetic wrench of a magnetic wrench system in an in-use condition according to an embodiment of the present invention.

FIG. 2 is a perspective view illustrating the magnetic wrench(es) according to an embodiment of the present invention of FIG. 1.

FIG. 3 is a perspective view illustrating a magnetic wrench of the magnetic wrench system in an in-use condition according to an alternate embodiment of the present invention of FIG. 1.

FIG. 4 is a perspective view illustrating the magnetic wrench according to an embodiment of the present invention of FIG. 1.

FIG. 5 is a flowchart illustrating a method of using the magnetic wrench(es) according to an embodiment of the present invention of FIG. 1.

The various embodiments of the present invention will hereinafter be described in conjunction with the appended drawings, wherein like designations denote like elements.

### DETAILED DESCRIPTION

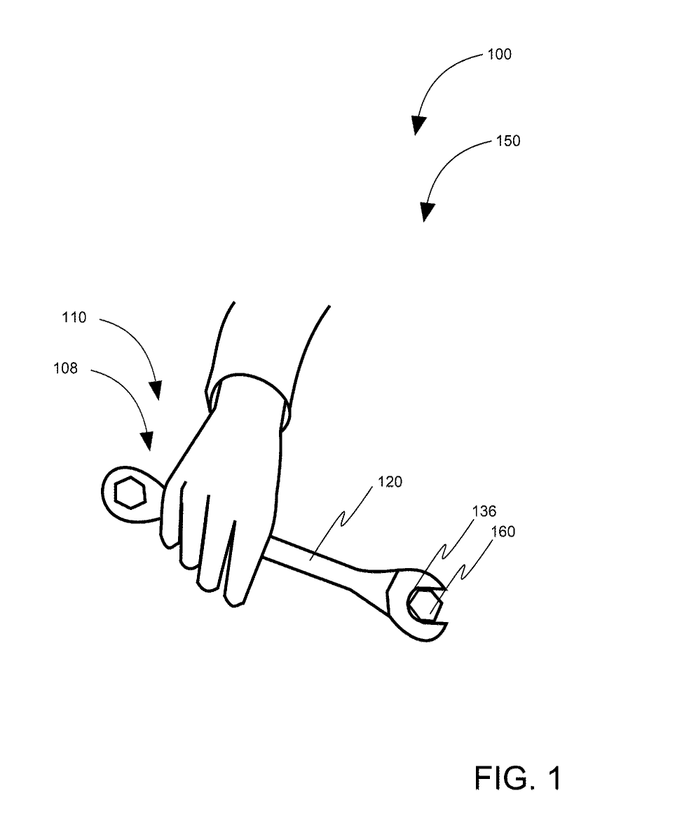

As discussed above, embodiments of the present invention relate to a wrench device and more particularly to a magnetic wrench as used to improve the efficiency in fastener installation and de-installation processes. Referring to the drawings by numerals of reference there is shown in FIG. 1, magnetic wrench 110 of magnetic wrench system 100 in an in-use condition 150 according to an embodiment of the present invention.

Magnetic wrench 110, as disclosed herein, is designed for providing mechanical torquing advantage for use with tightening and loosening of rotary fasteners 160. Magnetic wrench 110 preferably comprises: an elongated shank lever member 120 of suitable length for providing mechanical torquing advantage acting as a force moment arm lever; and at least one head 130 with a U-shaped opening 134. In preferred embodiments, magnetic wrench 110 typically comprises two heads 130, some may have one or two U-shaped openings 134 (or V-shaped in crescent wrench 320 versions) and in other versions may have one or two ring-ends 250. Other embodiments may have combinations of U-shaped openings 134 and ring-ends 250 on opposing first end 220 and second end 224. The various embodiments are shown in FIGS. 1-4.

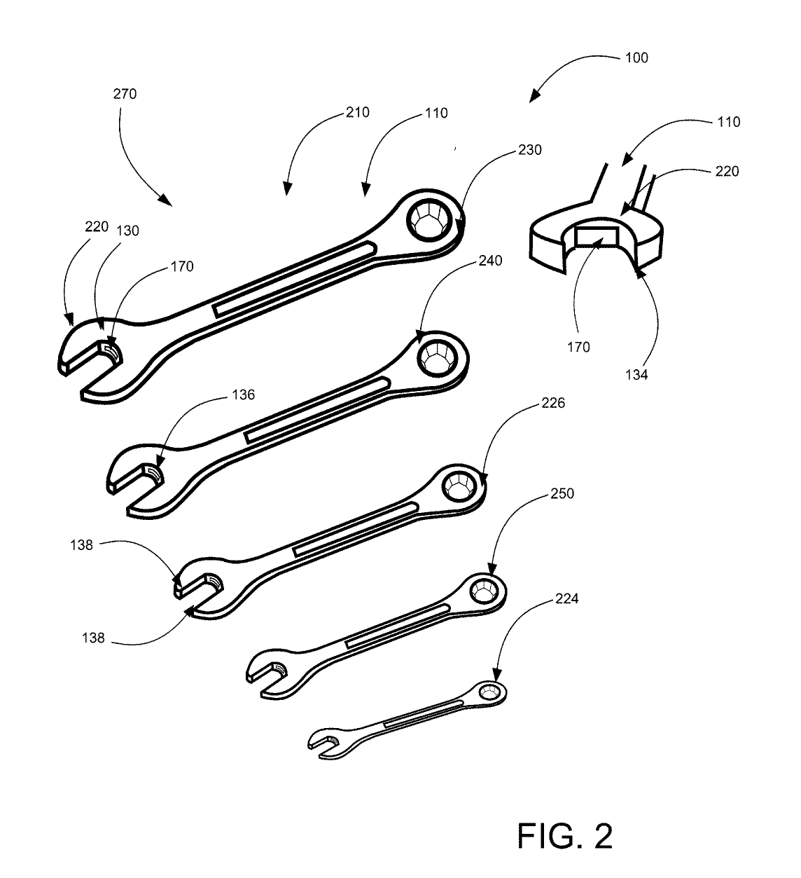

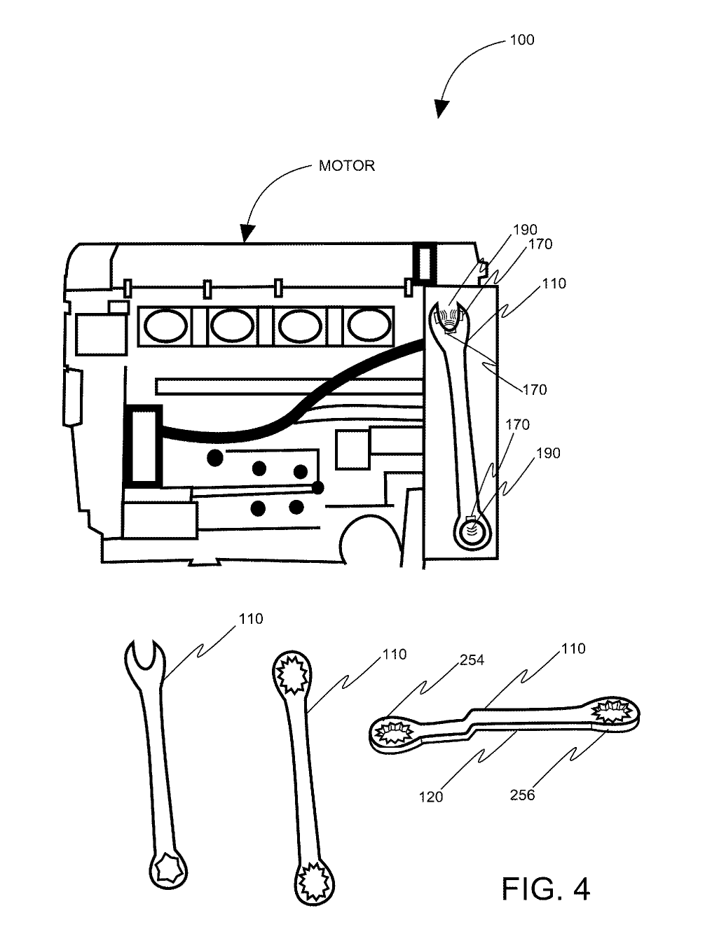

Magnetic wrench 110 in the embodiment shown in the present figure (FIG. 1) and in FIGS. 2 and 4 comprises a combination double-ended version 210 of continuous rigid manipulator tool 108 having a first end 220 comprising head 130 with U-shaped opening 134 and second end 230 comprising another head 240 having ring-end 250.

U-shaped opening 134 may have at least one base 136 and two opposite faces 138 suitable to contact-grip rotary fasteners 160. Two opposite faces 138 are substantially parallel with each other and serve to contact rotary fastener 160 in a frictional relationship whereby rotating about the centerline axis of a stationary fastener such as a bolt, magnetic wrench 110 when rotated via hand by user causes rotary fastener 160 to rotate up or down on threads of the stationary fastener allowing rotary fastener 160 to be loosened or tightened according to the direction of rotation. Contact-grip force is enhanced with imbedded flush-mounted permanent magnet 170, as further discussed in FIG. 2.

In an adjustable version of magnetic wrench 110, U-shaped opening 134 comprises two threadingly connected jaws 280 (via a worm and pinion gearing) allowing relationship-adjusting between jaws 280 to adapt U-shaped opening 134 to rotary fasteners 160 of different sizes. In the adjustable versions of magnetic wrench 110, jaws 280 may comprise serrated inner faces 310 to operate in the capacity of/as a pipe wrench 300 or alternately jaws 280 may comprise (smooth, non-serrated) flat surface inner faces 330 and operate as a crescent wrench 320. In pipe wrench 300 embodiments imbedded flush-mounted permanent magnet(s) 170 may be contoured to follow the serrations (at least herein embodying serration-contoured imbedded flush-mounted permanent magnet(s) 170). Within these and other embodiment of the present invention base 136 two opposite faces may each have imbedded flush-mounted permanent magnets 170 installed therein. Magnetic wrench 110 may further comprise a ratcheting mechanism in other versions. Faces may each have imbedded flush-mounted permanent magnets 170 installed therein. It should be appreciated that imbedded flush-mounted permanent magnets 170 may be installed in tools other that magnetic wrench 110, such as in sockets and other such tooling.

Referring now to FIG. 2, a perspective view illustrating magnetic wrench(es) 110 according to embodiment(s) of the present invention of FIG. 1.

Magnetic wrench 110 also comprises at least one imbedded flush-mounted permanent magnet 170 for creating a ferromagnetic force suitable to act on rotary fasteners 160 during at least one engagement. Elongated shank lever member 120 and head 130 form continuous rigid manipulator tool 108 to create a suitable, durable, rigid levering means. Imbedded flush-mounted permanent magnet 170 is preferably integral-mounted in U-shaped opening 134. In certain embodiments imbedded flush-mounted permanent magnet 170 may be replaceable with stronger/weaker versions according to user-preference. Further, in the embodiment shown, imbedded flush-mounted permanent magnet 134 comprises a horizontally-mounted position 180 within base 136 to provide contact-touch at least one surface area (surface area—not a point—for greater face contact) on rotary fastener 160 as a user torques rotary fastener 160, as shown in FIG. 1.

Horizontally-mounted position 180 of imbedded flush-mounted permanent magnet 134 comprises an orientation such that a north and a south pole 184 and 188, respectively, are surface-accessible to provide magnetic field 190 arcuate between north pole 184 and south pole 188 to apply a multi-pull attraction-force on rotary fastener 160, in part due to the relative horizontal length and orientation of imbedded flush-mounted permanent magnet 134. This permits user to manipulate elongated shank lever member 120 to torque-rotate rotary fastener 160 that is removably magnetically-secured to base 136 of U-shaped opening 134 via imbedded flush-mounted permanent magnet 170. Imbedded flush-mounted permanent magnet 134 within the particular embodiments shown preferably does not protrude from base 136, so as to not interfere with surface-contacting rotary fastener 160. Additionally this feature substantially protects imbedded flush-mounted permanent magnet 134 from incurring premature damage. In this way the present invention is made durable and provides cost-effective longevity for its users. Ring end 250 may comprise a six-point or twelve point enclosed opening (both shown in FIG. 4) that grips faces of rotary fastener 160.

Magnetic wrench system 100 may further comprising kit 270 including a set of sequentially sized magnetic wrenches 110 (as shown); a carrying pouch (not shown); an adjustable version of magnetic wrench (not shown on the present figure); and a user instruction/warranty manual (not shown). Sequentially sized magnetic wrenches 110 may come in metric and imperial sizes. As mentioned previously six and twelve-point closed-end versions may be available. Magnetic wrench system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less wrenches of various sizes, customized parts, adjustable versions, replacement magnet inserts, versions with different face finishes, different wrench types and combinations, parts may be sold separately, etc., may be sufficient.

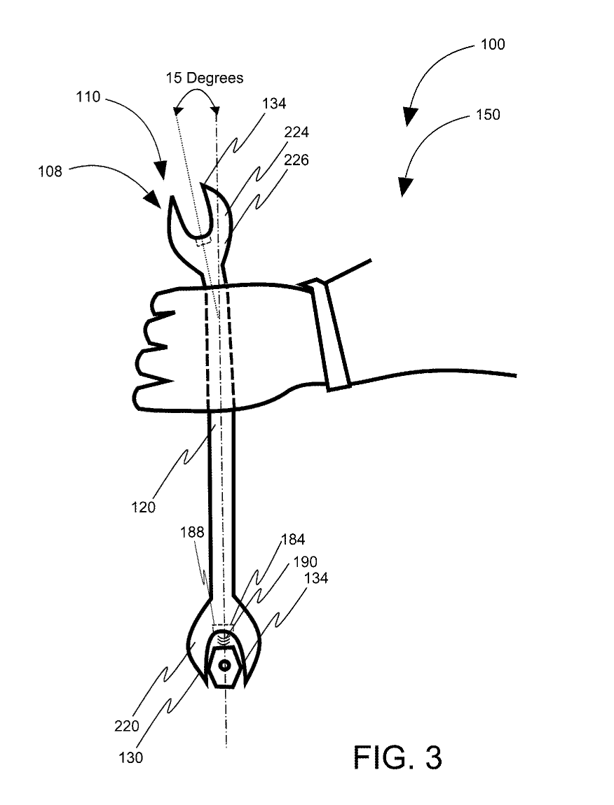

Referring now to FIG. 3, a perspective view illustrating magnetic wrench 110 of magnetic wrench system 100 in an in-use condition 150 according to an alternate embodiment of the present invention of FIG. 1.

Magnetic wrench 110, as shown, comprises a double-ended version 210 of continuous rigid manipulator tool 108 with first end 220 having head 130 with U-shaped opening 134 and second end 224 having head 226 with U-shaped opening 134. First end 220 and second end 224 may be oriented at an angle of about fifteen degrees to a longitudinal centerline axis of elongated shank lever member 120, as indicated. Grippable portion on elongated shank lever member 120 of magnetic wrench 110 is shown in dashed lines, (at least herein embodying magnetic wrench 110 being hand-grippable and hand-manipulatable) as shown.

Referring now to FIG. 4, a perspective view illustrating magnetic wrench 110 according to an embodiment of the present invention of FIG. 1.

The present figure shows that magnetic wrench 110 is very handy for example when working on equipment such as motors because it can be laid on the motor or other ferrous object and remain in place without falling or slipping due to the magnetic attraction of imbedded flush-mounted permanent magnets 170. In certain embodiments imbedded flush-mounted permanent magnets 170 may be flush-mounted in other portions such as in elongated shank lever member 120 for hanging or be removably attracted to a vertical or horizontal surface, such as for hanging or other. In this way the present invention effectively prevents loss of tools and time spent looking for tools, thus improving efficiency in mechanical repairing processes. Further, different embodiments are shown as exemplary means. These illustrated embodiments are not meant to be limiting, but rather provide an enabling means whereby a user can understand some of the possible applications within the scope of the invention.

In an embodiment shown first ring end 254 and second ring end 256 may be located on offset planes. In other embodiments they may be located on a single plane. Various angles and offsets may provide increased ease of use and efficiency in congested locations or those requiring different initiation angles for ‘starting’ tightening or loosening procedures. Magnetic wrench 110 in certain embodiments comprises first ring end 254 and second ring end 256 connected contiguously via elongated shank lever member 120, having imbedded flush-mounted permanent magnets 170 in first ring end 254 and second ring end 256. Those with ordinary skill in the art will now appreciate that upon reading this specification and by their understanding the art of wrenches as described herein, methods of manufacturing and using such wrenches will be understood by those knowledgeable in such art.

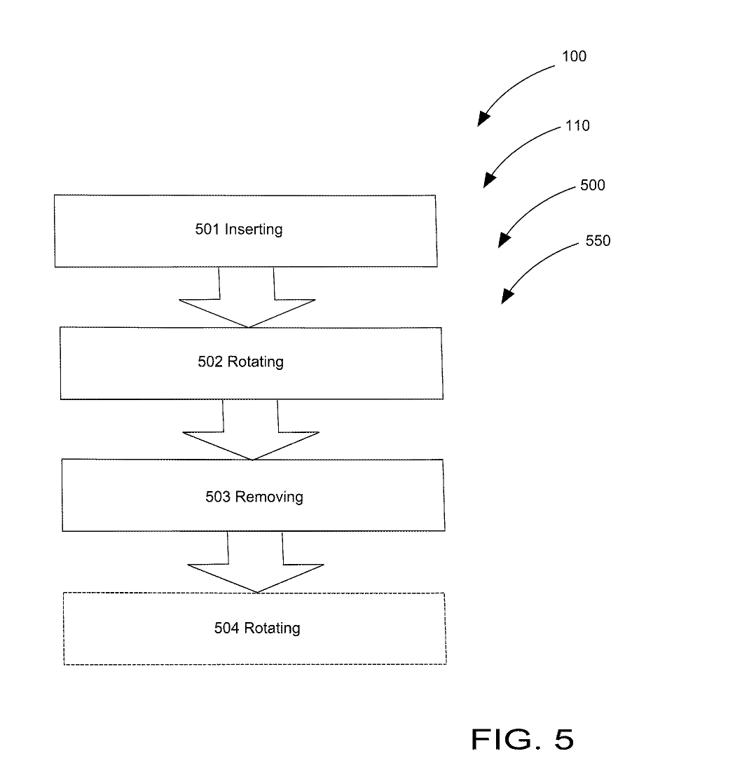

Watts Magnetic Wrench 110 of magnetic wrench system 100 provides consumers with magnetic Wrench 110 comprising imbedded flush-mounted permanent magnet 170 that substantially prevents the tool, nuts (rotary fastener 160) and bolts from being dropped when being loosened or tightened. In certain embodiments imbedded flush-mounted permanent magnets 170 may be located on other surfaces such as on a face portion, ends (not shown), along hand-holding portion, or other to facilitate desired magnetic effect(s). Use of the present invention is described in greater detail in FIG. 5.

Referring now to FIG. 5, a flowchart 550 illustrating a method of use 500 for magnetic wrench 110 according to an embodiment of the present invention of FIG. 1.

Method of use 500 for using magnetic wrench 110 with at least one (horizontal bar) imbedded flush-mounted permanent magnet 170 may comprise the steps of: step one 501 inserting rotatable fastener 160 into U-shaped opening 134 of magnetic wrench 110, U-shaped opening 134 having a horizontally imbedded flush-mounted permanent magnet 170 located in base 136 such that rotatable fastener 160 is removably magnetically secured in the U-shaped opening 134; step two 502 rotating rotatable fastener 160 onto a threaded relationship with a stationary fastener having a helical ridge (threaded portion); and step three 503 removing U-shaped opening 134 from a touch contact relationship with rotatable fastener 160. Method of use 500 may further comprise the optional step four 504 of rotating rotatable fastener 160, thereby removing the rotatable fastener 160 from the stationary fastener (bolt, stud or other). In other circumstances other stationary fastener(s) may be engaged, and in certain circumstances stationary fastener may not be stationary in nature.

It should be noted that step 504 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A wrench for providing mechanical torquing advantage for use with rotary fasteners comprising:
an elongated shank lever member suitable for providing said mechanical torquing advantage;
at least one head with a U-shaped opening, said U-shaped opening having a base and two opposite faces suitable to contact-grip said rotary fastener;
at least one imbedded flush-mounted permanent magnet for creating a ferromagnetic force suitable to act on said rotary fastener during at least one engagement;
wherein said elongated shank lever member and said head form a continuous rigid manipulator tool;
wherein said imbedded flush-mounted permanent magnet is integral-mounted in said U-shaped opening;
wherein said imbedded flush-mounted permanent magnet comprises a horizontally-mounted position within said base to contact-touch at least one surface area on said rotary fastener as a user torques said rotary fastener;
wherein said horizontally-mounted position of said imbedded flush-mounted permanent magnet comprises an orientation such that a north and a south pole are surface-accessible to provide a magnetic field arcuate between said north and said south poles to apply a multi-pull attraction-force on said rotary fastener;
wherein said user is able to manipulate said elongated shank lever member to torque-rotate said rotary fastener that is removably magnetically-secured to said base of said U-shaped opening via said imbedded flush-mounted permanent magnet.

2. The wrench of claim 1 wherein said wrench comprises a combination double-ended version of said continuous rigid manipulator tool having a first end comprising said head with said U-shaped opening and a second end comprising another head having a ring-end.

3. The wrench of claim 1 wherein said wrench is hand-grippable and hand-manipulatable.

4. The wrench of claim 1 wherein said wrench comprises a double-ended version of said continuous rigid manipulator tool with a first end having said head with said U-shaped opening and a second end having said head with said U-shaped opening and said first end and said second end are oriented at an angle of about fifteen degrees to a longitudinal axis of said elongated shank lever member.

5. The wrench of claim 2 wherein said ring end comprises a six-point enclosed opening that grips faces of said rotary fastener.

6. The wrench of claim 2 wherein said ring end comprises a twelve-point enclosed opening that grips faces of said rotary fastener.

7. The wrench of claim 1 wherein said wrench comprises a first ring end and a second ring end connected contiguously via said elongated shank lever member, having said imbedded flush-mounted permanent magnets in said first ring end and said second ring end.

8. The wrench of claim 7 wherein said first ring end and said second ring end are located on offset planes.

9. The wrench of claim 1 wherein said U-shaped opening comprises two threadingly connected jaws allowing relationship-adjusting between said jaws to adapt said U-shaped opening to said rotary fasteners of different sizes.

10. The wrench of claim 9 wherein said jaws comprise serrated inner faces and operate as a pipe wrench and said imbedded flush-mounted permanent magnet(s) are serration-contoured.

11. The wrench of claim 9 wherein said jaws comprise flat surface inner faces and operate as a crescent wrench.

12. The wrench of claim 1 wherein said base and said two opposite faces each have imbedded flush-mounted permanent magnets installed therein.

13. The wrench of claim 1 wherein said wrench further comprises a ratcheting mechanism.

14. A magnetic wrench system comprising:
an elongated shank lever member suitable for providing a mechanical torquing advantage which is hand-grippable and hand-manipulatable;
a first head located on a first end with a U-shaped opening, said U-shaped opening having a base and two smooth opposing symmetrical parallel inner faces suitable to contact-grip a rotary fastener;
a second head located on a second end, said first end connected to said second end via said elongated shank lever member, said second head having at least a six point ring-end, with a plurality of adjoined faces suitable to contact-grip said rotary fastener;
at least one imbedded flush-mounted permanent magnet for creating a ferromagnetic force suitable to act on said rotary fastener during at least one engagement;
wherein said elongated shank lever member and said first and second heads form a continuous rigid manipulator tool;
wherein said imbedded flush-mounted permanent magnet is integral-mounted in said U-shaped opening and said ring-end;
wherein said imbedded flush-mounted permanent magnet(s) comprise a horizontally-mounted position within said base to contact-touch at least one surface area on said rotary fastener as a user torques said rotary fastener;
wherein said horizontally-mounted position of said imbedded flush-mounted permanent magnet(s) comprise an orientation such that a north and a south pole are surface-accessible to provide a magnetic field arcuate between said north and said south poles to apply a multi-pull attraction-force on said rotary fastener;
wherein said user is able to manipulate said elongated shank lever member to torque-rotate said rotary fastener that is removably magnetically-secured to said base of said U-shaped opening or said ring-end via said imbedded flush-mounted permanent magnet.

15. The magnetic wrench system of claim 14 further comprising a kit including a set of sequentially sized said magnetic wrenches; a carrying pouch; an adjustable version of said magnetic wrench; and a user instruction/warranty manual.

16. A method for using a wrench with an imbedded flush-mounted permanent magnet comprising the steps of:
inserting a rotatable fastener into a U-shaped opening of said wrench, said U-shaped opening having a horizontally imbedded flush-mounted permanent magnet located in a base such that said rotatable fastener is magnetically secured in said U-shaped opening;
rotating said rotatable fastener onto a threaded relationship with a stationary fastener having a helical ridge; and
removing said U-shaped opening from touch contact with said rotatable fastener.

17. The method of claim 16 further comprising the step of rotating said rotatable fastener thereby removing said rotatable fastener from said stationary fastener.
